(19) United States
(12) Patent Application Publication
(10) Pub. No.: US 2021/0069737 A1
(43) Pub. Date: Mar. 11, 2021

(54) SYSTEM TO PREVENT LEAKS OF LIQUIDS IN MANUAL SPRAYERS

(71) Applicant: Swissmex-Rapid, S.A. de C.V., Lagos de Moreno (MX)

(72) Inventor: Pedro Wirz Luchsinger, Lagos de Moreno (MX)

(21) Appl. No.: 16/952,015

(22) Filed: Nov. 18, 2020

Related U.S. Application Data
(63) Continuation of application No. 15/501,788, filed on Feb. 3, 2017.

(30) Foreign Application Priority Data
Aug. 4, 2014 (MX) MX/U/2014-000383

(51) Int. Cl. B05B 9/08; B05B 9/04; F04B 9/14; F04B 19/22; F04B 23/02

(52) U.S. Cl. CPC B05B 9/0877; B05B 9/0413; F04B 53/14; F04B 19/22; F04B 23/025; F04B 9/14

(57) ABSTRACT

System to prevent leaks of liquids in a manual sprayer—insecticides, herbicides, fungicides—comprised by a large storing tank in which a recipient is installed under pressure. A pumping assembly, which is manually activated, is connected to the inferior part of the container under pressure and to the lower part of the tank. The pumping assembly is comprised of an alternative piston to extract the liquid from the storing tank and to pressurize it inside the container under pressure. The pressurized liquid is applied using a hose and a regulating valve attached to the container under pressure. The pumping ensemble is comprised as well by a double-walled piston and a barrier against leaks of the piston, formed by a flexible sealing accordion with four lobes or waves that avoid grazing the cylinder and that prevent leaking from taking place between the superior side of the piston and the inferior side of the piston chamber, thus blocking the exit of liquid and forcing it to stay at the collection chamber until it is once again emptied thanks to the descending movement of the piston. The liquid is therefore taken back from the collection chamber to the storing tank by means of a returning hose, of an internal duct and of a siphon that unloads above the liquid level.

### RELATED APPLICATION

This patent application is a continuation of copending U.S. patent application Ser. No. 15/501,788 filed Feb. 3, 2017, which is a national stage filing under 35 U.S.C § 371 of PCT International Patent Application No. PCT/IB2015/001315 entitled System to Prevent Leaks of Liquids in Manual Sprayers, filed Aug. 3, 2015, which claims priority to Mexican Patent Application No. MX/u/2014/000383 filed Aug. 4, 2014, 2012, the entire disclosure of each such application being expressly incorporated herein by reference.

### FIELD OF THE INVENTION

The present invention relates generally to the fields of mechanical engineering and fluid dynamics, and more particularly to sprayer systems useable for spraying or dispensing agrochemicals or other substances.

### BACKGROUND

This invention belongs to the field of industry dedicated to designing and manufacturing agricultural equipment, especially manual sprayers to apply insecticide, herbicide or fungicide.

In the field of this invention, currently known portable manual equipment used to pump liquid works based on systems of gears, systems of piston or pistons, diaphragm systems or combined systems of piston and diaphragm. Some of these systems were protected by means of Mexican patents number 156904, 157782, 157783, 160084, 160085, 165049, 185553. In all of these systems, an intense use or the aggressive effect of certain kinds of chemicals can cause some of the components to wear out due to friction or softening, and as a consequence there may be leaks of liquids through the bottom part of the sprayer, thus wetting the operator's back and damaging the environment.

Mexican patent number 225563 implemented a system to prevent leaks of liquid. In such system, the leaks of the piston chamber are deposited in a primary collection chamber. The resulting liquid is expelled from the system thanks to the action of the swinging movement of the piston when ascending to a second collection chamber, and when the movement goes down it is pumped through a returning siphon to the interior of the tank.

In the request for the Mexican patent number 2012/014050 such system to prevent leaks was improved with a barrier represented by a seal against leaks: by means of a compact ring with interior lips or rims, it simplifies the return of the liquid into the interior of the tank through internal conduits without drilling the tank.

Currently such system to prevent leaks has been perfected by means of a barrier comprised by a seal formed by a flexible accordion used to seal with lobes or waves, which avoids grazing the cylinder, thus increasing its duration and its pumping capacity. Combined with an internal duct and a siphon, it takes the liquid that has leaked back into the interior of the tank.

### SUMMARY

In accordance with the present invention, there is provided a sprayer system which comprises a) a tank having a lower wall with an opening formed therein and an interior chamber; b) a container positioned within the interior chamber of the tank, a lower portion of the container being attached by a fluid tight seal about the opening formed in the lower wall of the tank; c) a siphon positioned within the interior chamber of the tank, said syphon having a too end opening and d) a pump assembly attached to a lower part of the container. The pump assembly comprises i) a cylindrical piston chamber having an outer surface and an inner surface, and ii) a piston that is reciprocally movable back and forth within the piston chamber. The piston comprises a piston head and a piston body. The piston body comprises an inner wall, an outer wall and a collection chamber between the inner wall and the outer wall. A flexing seal member has an upper end attached to the outer surface of the piston chamber, a bottom end attached to the outer wall of the piston body and a mid-portion that flexes back and forth between a long configuration and a short configuration in accordance with back and forth movement of the piston within the piston cylinder. Any liquid that leaks between the piston and the inner surface of the piston cylinder is received within the collection chamber. The collection chamber is connected to the syphon. The flexing of the seal member creates pressure changes within the collection chamber which expel liquid that collects within the collection chamber though the syphon, out of the syphon's top end opening, and into the interior chamber of the tank.

Further in accordance, the flexing seal member may be of any suitable construction or configuration. For example, in some embodiments, the flexing seal member may comprise a bellows or accordion having flutes, formed of rubber or suitable elastomeric material. In other embodiments, the flexing seal member may comprise a flexible tube which compresses, everts (e.g., folds or laps over itself), or otherwise transitions between the long and short configurations.

Still further in accordance with the present invention, in some embodiments, the pump may comprise a manual pump having a pump handle which an operator moves back and forth between an up position and a down position and wherein the flexing seal member transitions from its long configuration to its short configuration as the pump handle moves from its up position to its down position. In such embodiments, the flexing seal member may be constructed such that the compression, folding, everting, bunching or other movement of its material creates resistance or a cushioning effect as the pump handle reaches its down position and the piston reaches its maximum stent of advancement. This will facilitate a soft stopping of the downward motion of the pump handle and will deter hard impacting or “slamming” of pump components as could otherwise result of forceful or aggressive movement of the pump handle to its furthest downward stopping position.

Still further in accordance with the invention, in some embodiments, the collection chamber may be connected to the syphon by way of a flexible tube or hose and an internal duct.

Still further in accordance with the invention, in some embodiments, the tank has a fill line or other indicator indicating the highest level to which the interior chamber is to be filled and the top end opening of the syphon may be positioned above the fill line or other indicator indicating the highest level to which the interior chamber is to be filled. Thus, when the tank is sealed, the intended syphon effect will occur and liquid will flow out of the open top end of the syphon above the level of standing liquid within the tank.

Still further aspects, elements, uses and objects of the invention will be apparent to those of skill in the relevant art upon reading the following detailed descriptions of examples and reference to the accompanying drawings.

### BRIEF DESCRIPTION OF THE DRAWINGS

FIG. 1 is a front sectional view of a preferred execution form of this invention.

FIG. 2 is a detailed sectional view of a portion of the device of figure No. 1.

FIG. 3 is a side sectional view of the barrier against leaks.

FIG. 4 is a side sectional view of the piston, the leak collection chamber, internal ducts and siphon.

FIG. 5 is a side view of the bellows or accordion type sealing member of the sprayer device of FIGS. 1-4.

FIGS. 6A and 6B show an alternative tube type sealing member useable in the sprayer device of FIGS. 1-4. FIG. 6A shows a cross-sectional view of the tube type sealing member while in a non-everted/long configuration. FIG. 6B, shows a cross-sectional view of the tube type sealing member while in an everted/short configuration.

FIG. 6C is a perspective view of the tube type sealing member in its non-everted/long configuration and connected to adjacent components of the sprayer device.

FIG. 6D is a perspective view of the assembly of FIG. 6C, with the tube type sealing member in its everted/short configuration.

### DETAILED DESCRIPTION OF EXAMPLES

The following detailed description and the accompanying drawings to which it refers are intended to describe some, but not necessarily all, examples or embodiments of the invention. The described embodiments are to be considered in all respects only as illustrative and not restrictive. The contents of this detailed description and the accompanying drawings do not limit the scope of the invention in any way.

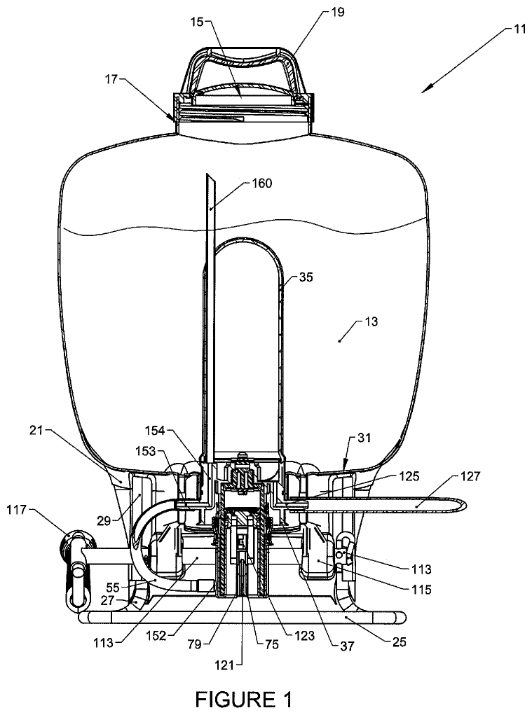

FIG. 1 shows a preferred execution form of the portable sprayer 11, comprised by a liquid storing tank 13 preferably manufactured using a synthetic resin and other similar light and durable materials. It has a substantially flat backside—not shown—adapted to lean against the back of the operator. Once the storing tank 13 is full with liquid chemicals such as insecticides, herbicides, fungicides, etc. and it is ready to be used, a threaded lid 19 preferably seals the filling opening 15.

The lower back portion of the storing tank 13 has a supporting structure that is fully molded 21, shoes back side is substantially connected to the back side of the storing tank 13 in such a way that the whole structure is placed against the back of the operator. In the upper back portion of the storing tank 13 there are solid openings designed to hold the shoulder straps—not shown—which are extended over the shoulders and then drop to be secured to a supporting stretcher 25 which is located at a generally horizontal level. The ends of the supporting stretcher 25 are folded upwards to form legs 27 that are firmly secured to the vertical stud 29 of the supporting structure 21.

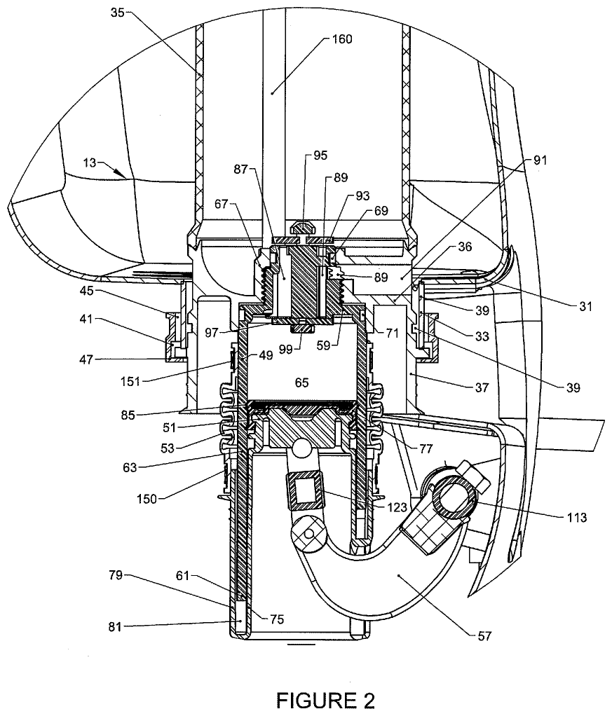

In regards to the following FIG. 2, as well as to FIG. 1, the inferior wall 31 of the storing tank 13 is generally horizontal and has a relatively large opening of the container, defined by a cylindrical flange folded downwards 33 which goes from the inferior wall 31. A container under pressure 35 that has been vertically stretched is inserted through the opening of the container, stretching inside the storing tank 13. The container under pressure 35 is manufactured using a strong material, preferably a synthetic resin able to withstand the pressure created in it due to the operation of the pump, described as follows.

The lower portion of the container under pressure 35 comprises an externally cylindrical end 37 that is tightly fitted against the internal cylindrical surface of the flange 33. The cylindrical end 37 comprises a first slot or groove with the form of a ring 39 integrated to the external surface of the cylindrical end 37 and a radial end flange 41. An O-ring is placed at the first slot with the form of a ring 39 in order to provide a seal between the cylindrical end 37 and the flange 33. When the container under pressure 35 is inserted into the storing tank 13, the flange of the radial end 41 leans against the flange 33 in order to avoid having the container under pressure 35 sliding more in the storing tank 13. The container under pressure 35 is firmly held in place and the seal between the cylindrical end 37 and the flange 33 is strengthened by applying the adequate mechanical pressure, as well as by using a radial end flange of a large diameter 41, installed and tightened around the flange 33 and the container under pressure in its cylindrical end 37. The final lugs 47 circumferentially separated from the end flange 41—shown in FIG. 2—are fitted to the clamp 45; the lugs 47 are placed around the radial end flange 41, and combined with the clamp 45, they immobilize the container under pressure 35 in regards to the storing tank 13.

As it can be seen in FIG. 2, a pumping ensemble is placed at the lower wall 36 of the container under pressure 35 inside the cylindrical end 37. The pumping ensemble is mainly formed by a pump cylinder 49, an alternative piston 51, a barrier against leaks 81, a returning hose 55 (FIG. 1) and a piston balance 57 (FIG. 2). The pump cylinder 49 is preferably manufactured using a synthetic resin material and is comprised of an upper end 59 which stretches along the lower wall 36 integrated to the container under pressure 35 and a lower open end 61 with a cylinder wall 63 which defines a piston chamber of smooth walls 65. The general length of the cylinder wall 63 is preferably at least double of the total linear displacement of the piston 51 during its operation, as it is hereby described. The upper end 59 has external threads that match with the internal threads of a portion of the internal rim 67 of the container under pressure 35. The container under pressure 35 is sealed against leaks placed at the two ring-like slots 69 and 71 formed at the upper end 59 of the pump cylinder 63. The first slot with the form of a ring 69 is placed in such a way that it creates a seal between the rim portion 67 and the upper end 59, and the second slot with the form of a ring 71 is placed in such a way that it creates a seal between the upper end 59 and the lower wall 36 of the container under pressure 35.

The piston 51 is preferably manufactured using a synthetic resin material, it is comprised of an internal wall 75 that has an integral piston head 77 soft at an end, and at the other end the internal wall 75 folds over itself in order to create and external wall 79. The soft piston head 77 and the internal wall 75 are placed inside the piston chamber 65 and the external wall 79 is placed outside the piston chamber 65, in such a way that the cylinder wall 61 is placed between the internal and external walls 75, 79.

The combination of the cylinder wall 61, the internal wall 75 and the external wall 79 of the piston define a leak collection chamber 81, which collects any liquid leaking from the piston. During the operation, the piston goes from a first position—shown in FIG. 1—in which the piston head 77 is located at the upper end 59 of the piston chamber 65 (maximum position of the upper piston's section) and a second position—shown in FIG. 2—in which the piston head 77 is lineally moved away from the upper end 59 of the piston chamber 65 (minimum position of the lower piston's section).

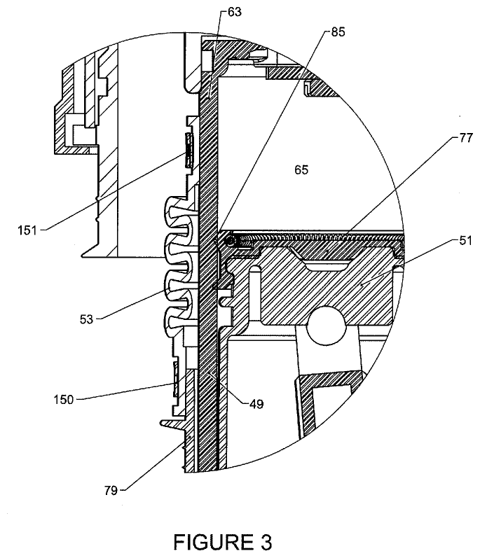

A stem tapered piston cup 77 (FIG. 3) manufactured out of an adequate flexible material and preferable a resilient plugging device (nonporous) is placed on the head of the piston 51. The piston cup 77 has a plugging rim 85 that is kept against the wall of the cylinder 63 by the resilience of the cup 77 and by the pressure inside the piston chamber 65. When the piston 51 moves towards the upper end 59 (FIG. 2) of the cylinder of the pump 49, henceforth the “ascending movement”, the pressure at the piston chamber 65 increases and the upper sealing ring 85 is pressed harder against the wall of the cylinder 63. When the piston 51 moves away from the upper end 59 of the cylinder of the pump 49, henceforth the “descending movement”, the pressure at the piston chamber 65 decreases.

The upper end 59 of the cylinder is comprised additionally of an exit conduit 87 (FIG. 2) which allows the liquid to flow from the piston chamber 65 into the container under pressure 35 and an entrance conduit 89 which, in combination with the entrance slot 91 in the container under pressure 35, allows the liquid to flow from the storing tank 13 to the piston chamber 65. A first flexible valve disc 93 is installed at a knob 95, which is included at the upper external end 59 of the pump cylinder 49 in such a way that the first disc 93 is placed on the end of the exit conduit 87. A second flexible valve disc 97 is kept in its place using a screw 99, which is screwed into the lower end 59 of the pump cylinder 49.

When the piston 51 is located in its ascending position, the lowered pressure of the piston chamber 65 will remove the liquid from the storing tank 13 through the entrance conduits 91 and 89 to the piston chamber 65, the first disc 93 will block the exit conduit 87 and no liquid will flow into the piston chamber 65 from the container under pressure 35. When the piston 51 is located at the ascending position, pressure rises in the piston chamber 65 thus forcing the liquid of the piston chamber 65 through the exit conduit 87 to the container under pressure 35, but due to the augmented pressure at the piston chamber 65 the second disc 97 will block the entrance conduit 89 and no liquid will flow into the storing tank 13 from the piston chamber 65.

Therefore, thanks to the repeated ascending and descending movements of the alternative piston 51, the liquid will be pumped from the storing tank 13 and pressurized inside the container under pressure 35.

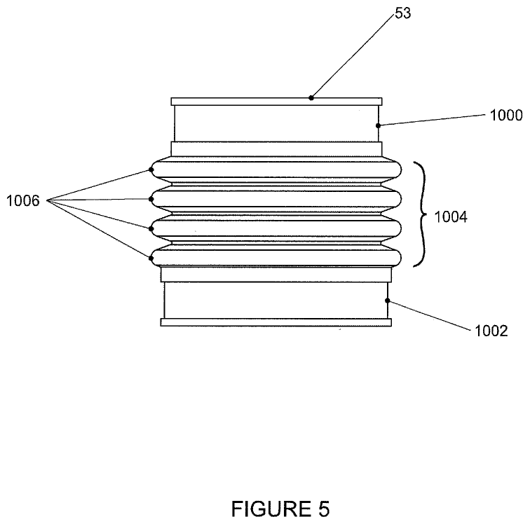

As seen in FIGS. 3-5, in this example, the flexing sealing member comprises a sealing bellows or accordion 53. As seen in the separate view of FIG. 5, this accordion 53 comprises a generally tubular structure having an upper portion 1000, a lower portion 1002 and a mid-portion 1004. The mid-portion 1004 comprises a plurality of flutes, lobes or waves 1006. The accordion 53 may be manufactured of any adequately flexible and durable material such as a rubber or elastomer that is resistant to weather conditions and to any chemicals that the sprayer may be used to deliver. The upper and lower portions 1000, 1002 of this accordion 53 are attached by suitable attachments 150, 151, such as hose clamps comprising metallic straps with screws to tighten them, to the upper and lower parts, as seen in FIG. 3. As shown, the first attachment 150 attaches the bottom end portion 1002 of the accordion 53 to the lower part and compresses it against the external wall of the piston 79. The second attachment 151 attaches the upper end portion 1000 of the accordion 53 to the upper part and compresses it against the wall of the cylinder 63. In this manner, the sealing accordion 53 reduces frictional wear on the cylinder 63 by preventing any abrasive matter from entering and causing excessive wear on the walls of the cylinder 63. This is especially advantageous in applications where the sprayer is being used to deliver agrochemicals or other agents that comprise suspensions or wetable powders.

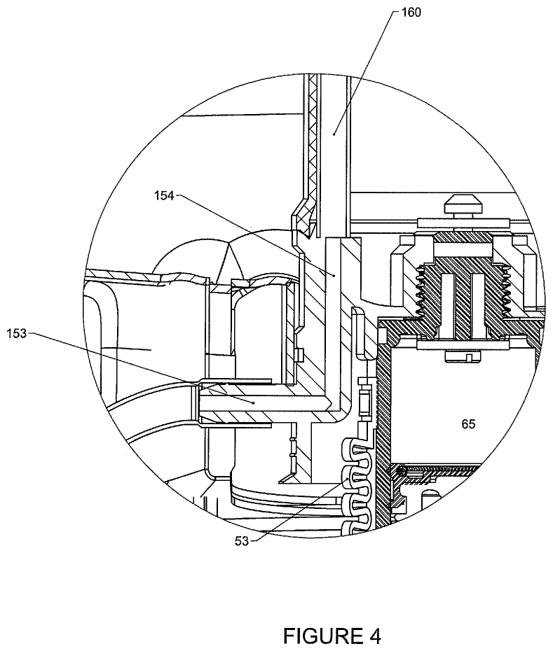

Also, the sealing accordion 53 (FIG. 2) prevents any liquid that leaks past the piston 51 liquid from exiting the collecting chamber 81. On each descending stroke of the piston 51, the accordion 53 will compress and the liquid inside the chamber 81 will be thereby expelled through port 152 (see FIG. 1), through hose 55, into port 153 (FIG. 4), through duct 154, through siphon 160 and to the interior of the tank 13 above the liquid level within the tank 13 (FIG. 1). The upper end of the siphon 160 is preferably located above the liquid level even when the tank 13 has is filled to its recommended fill line or maximum recommended capacity.

As long as the frustoconical cup 77 (FIG. 2) and its upper sealing lip or rim 85 do not leak, no liquid will get to the collecting chamber 81. Whenever the upper rim 85 leaks, there will be liquid going to the chamber 81. When the piston moves upwards, the accordion 53 will stretch and absorb air by means of the siphon 160, ducts 154, 153, 152 and hose 55. During its downwards movement, the accordion 53 compresses and as long as there is no leak or liquid, it simply pumps air, and if there is liquid then it is expelled from the collecting chamber 81 through the duct 152, the hose 55, the ducts 153, 154 and the siphon 160, until it is deposited in the tank over the level of the liquid.

As it is shown in FIG. 1, the crank portion of the piston of the pump ensemble carries out the balancing action of the piston and it includes a horizontal rotating rung 113 fully installed at the support structure 21 using bearings 115. The rung 113 is connected to a handle 117 that is used by the operator with a great mechanical usefulness to rotate the rung 113 and alternate the piston 51. A bent crank 57 (FIG. 2) is installed in a fixed manner over the rung 113, in a way in which the bent crank 57 (FIG. 2) is centered on the piston 51. The bent crank 57 is attached to the center of the piston 51 by passing through a slot 121 (FIG. 1) on the internal and external walls 75, 79 that are adequately connected to maintain the integrity of the collecting chamber 81 and the wall of the cylinder 63 as it is shown in FIG. 2. The slot 121 (FIG. 1) will preferably be no longer than the total linear length of the piston's movement 51 during its balancing movement.

With reference to FIG. 2, the bent crank 57 is preferably connected with a rotation capacity to an extension 123 that, in due time, is connected with a rotating capacity to the piston 51. The double pivot connection between the bent crank 57 (FIG. 2), the extension 123 and the piston 51 allows flexibility, precisely where the rung 113 is installed to the support structure 21.

Such flexibility substantially avoids having the piston 51 stuck at the piston's chamber 65 during the balancing movement.

In regards to FIG. 1 once again, once the liquid is pressurized inside the container under pressure 35, it is emptied through a pressure exit 125 at the cylindrical end 37 of the container under pressure 35. The pressure exit 125 joins a hose 127 with plugging capacity and a regulation valve 129—not shown—that is used by choice of the operator to empty the pressurized liquid from the container under pressure 35.

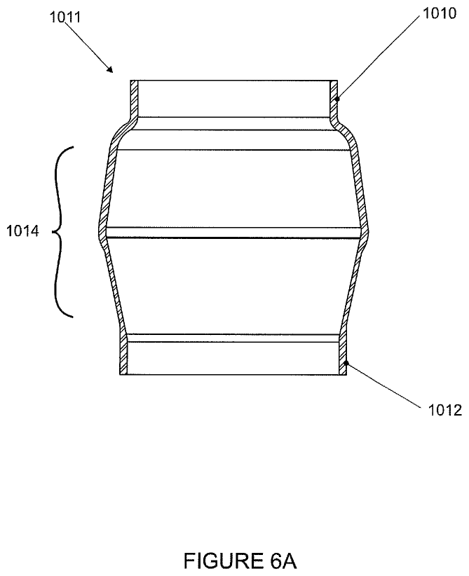

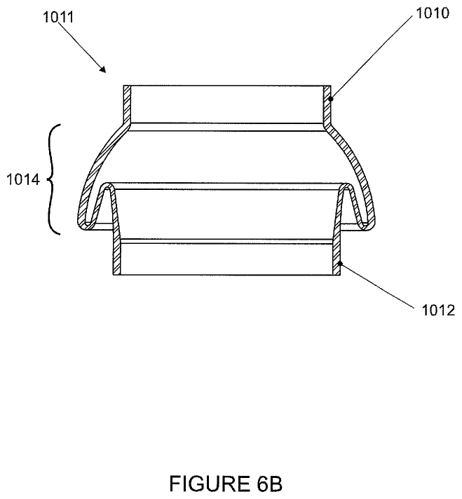

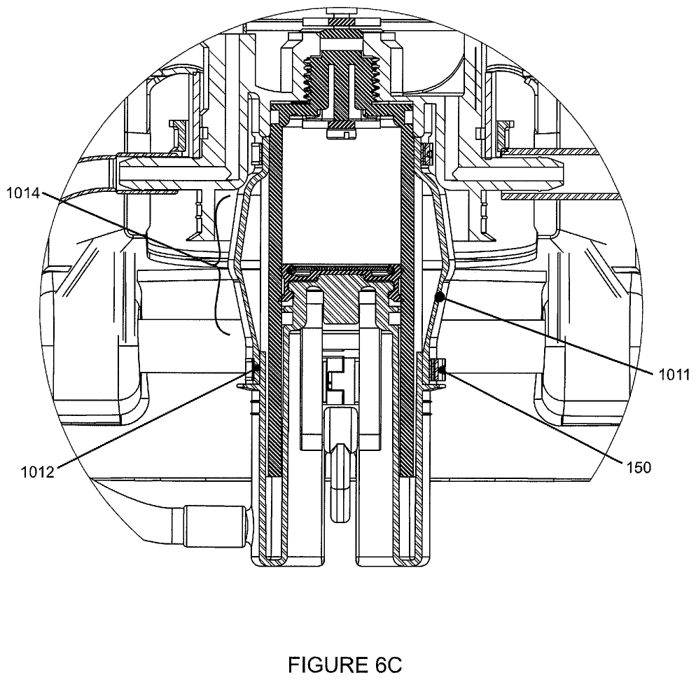

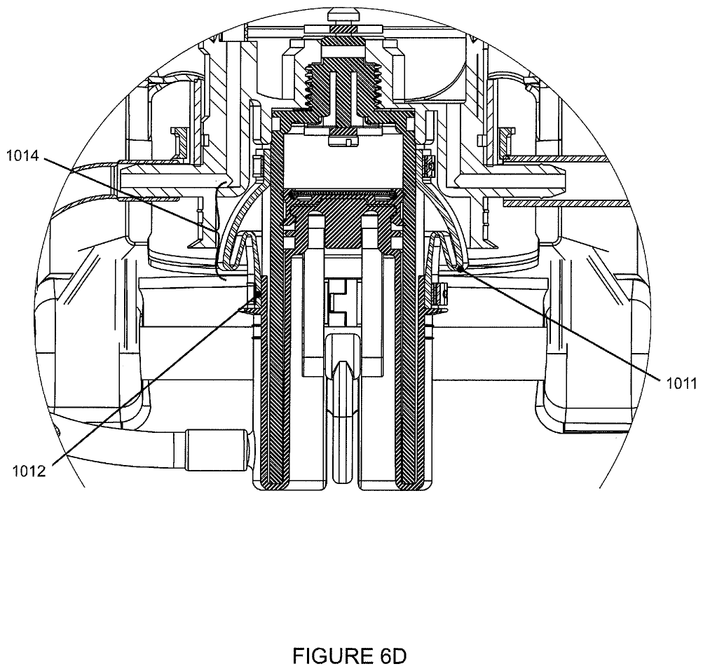

FIGS. 6A through 6D show a sprayer device having the same components as described above with respect to FIGS. 1-4, but wherein the flexing seal member comprises a flexing tube 1011 instead of the bellows or accordion 53. This flexing tube transitions back and forth between a non-everted/long configuration (seen in FIGS. 6A and 6C) and a, everted/short configuration (seen in FIGS. 6B and 6D) in accordance with back and forth movement of the piston 51 within the piston cylinder 63.

In this alternative embodiment, the flexing tube 1011 may be manufactured of any adequately flexible and durable material such as a rubber or elastomer that is resistant to weather conditions and to any chemicals that the sprayer may be used to deliver. The flexing tube 1011 has an upper portion 1010, a lower portion 1012 and a mid-region 1014. As seen in the cross sectional views of FIGS. 6A and 6B, in this non-limiting example, approximately the top half of the mid-region 1014 has a thicker side wall than that of the approximate bottom half of the mid-region 1014. This construction of the flexing tube 1011 allows its side wall to evert (e.g., fold or lap over itself) as it transitioned from a non-everted/long configuration (seen in FIGS. 6A and 6C) to its everted/short configuration (seen in FIGS. 6B and 6D).

In either embodiment, as the flexing seal member (e.g., accordion 53 or flexing tube 1011) transitions from its long configuration to its short configuration, its material may compress or create increasing resistance thereby providing a cushioning effect as the piston 51 reaches its furthest extent of advancement. This cushioning effect may be particularly advantageous in manual sprayers if a type where a pump handle is manually moved by the operator and may be subject to forceful slamming against its maximum point of travel thereby causing damage or excessive wear to components of the system. For example, in some sprayers, an operator moves back and forth between an up position and a down position. In such sprayers, the flexing seal member 53 or 1011 may transitions from its long configuration to its short configuration as the pump handle moves from its up position to its down position and may thereby provide a cushioning effect as the pump handle reaches its down position.

It is to be appreciated that, although the invention has been described hereabove with reference to certain examples or embodiments of the invention, various additions, deletions, alterations and modifications may be made to those described examples and embodiments without departing from the intended spirit and scope of the invention. For example, any elements, steps, members, components, compositions, reactants, parts or portions of one embodiment or example may be incorporated into or used with another embodiment or example, unless otherwise specified or unless doing so would render that embodiment or example unsuitable for its intended use. Also, where the steps of a method or process have been described or listed in a particular order, the order of such steps may be changed unless otherwise specified or unless doing so would render the method or process unsuitable for its intended purpose. Additionally, the elements, steps, members, components, compositions, reactants, parts or portions of any invention or example described herein may optionally exist or be utilized in the absence or substantial absence of any other element, step, member, component, composition, reactant, part or portion unless otherwise noted. All reasonable additions, deletions, modifications and alterations are to be considered equivalents of the described examples and embodiments and are to be included within the scope of the following claims.

What is claimed is:

1. A sprayer system comprising:
a tank having an inner chamber;
a sprayer connected to the inner chamber; and
a pump assembly assembly comprising a piston chamber having an outer surface and an inner surface and a piston reciprocally movable back and forth within the piston chamber;
said piston being connected to a crank by a double pivot connection in which the crank is pivotally attached to an extension and the extension is pivotally attached to a center of piston, said crank being also connected to a pump handle such that up and down movement of the pump handle causes alternating back and forth movement of the crank which in turn causes said reciprocal back and forth movement of the piston via the double pivot connection.

2. A system according to claim 1 further comprising:
a container positioned within the interior chamber of the tank, a lower portion of the container being attached by a fluid tight seal about the opening formed in the lower wall of the tank; and
a siphon comprising a tube within the tank that extends upwardly from the lower wall and has a top end opening positioned above the upper liquid level;
the piston comprising an inner wall, an outer wall and a collection chamber between the inner wall and the outer wall;
a flexing seal member comprising a sealing bellows or accordion having an upper end, a bottom end and a mid-portion which comprises a plurality of flutes, lobes or waves that flex back and forth between a long configuration and a short configuration in accordance with back and forth movement of the piston within the cylindrical piston chamber;
a first attachment attaching the bottom end such that it is compressed against the outer wall of the piston and a second attachment attaching upper end such that it is compressed against the wall of the cylinder thereby preventing any abrasive matter from entering the cylinder;
wherein, upward movement of the pump handle causes the piston to move forth, resulting in lowered pressure in the piston chamber thereby causing liquid to move from tank through entrance conduits and into the piston chamber and, thereafter, downward movement of the pump handle causes the piston to move back, resulting in increased pressure in the piston chamber thereby forcing liquid out of the piston chamber through the exit conduit, through the siphon, out of the top end opening of the syphon located above the upper liquid level while a second disc blocks entrance conduit such that no liquid flows into the tank from the piston chamber;
wherein any liquid that leaks between the piston and the inner surface of the piston cylinder is received within the collection chamber; and
wherein the collection chamber is connected to the syphon; and
wherein flexing of the seal member creates pressure changes within the collection chamber thereby expelling liquid that collects within the collection chamber though the syphon.

3. A system according to claim 1 wherein the flexing seal member provides a cushioning effect as the pump handle reaches its down position.

4. A system according to claim 1 wherein the collection chamber is connected to the syphon by way of a hose and an internal duct.

5. A system according to claim 1 wherein the tank has a fill line or other indicator indicating the highest level at which said upper liquid level is to be located.

6. A system according to claim 5 wherein the top end opening of the syphon is positioned above a fill line or other indicator indicating the highest level to which the interior chamber is to be filled.
